(19) United States
(12) Patent Application Publication
(10) Pub. No.: US 2024/0162608 A1
(43) Pub. Date: May 16, 2024

(54) SYSTEMS AND METHODS FOR ROW COLUMN PHASED ARRAY ANTENNAS

(71) Applicant: Agile RF Systems LLC, Berthoud, CO (US)

(72) Inventor: Philip Keith Kelly, Berthoud, CO (US)

(21) Appl. No.: 18/504,902

(22) Filed: Nov. 8, 2023

Related U.S. Application Data
(60) Provisional application No. 63/424,681, filed on Nov. 11, 2022.

(51) Int. Cl. H01Q 3/36; H01Q 1/02; H01Q 9/04

(52) U.S. Cl. CPC H01Q 3/36; H01Q 1/02; H01Q 9/0407

(57) ABSTRACT

Power efficient phased array antenna systems including a multilayered phased array antenna system using row-column phased array architecture and even a multi-unit cell chip which can be associated with several antennas in a phased array antenna system. Unit chips may include but are not limited to multipliers, mixers, amplifiers, local oscillator, radiator, or the like.

This application is a U.S. Nonprovisional Patent Application claiming priority to and the benefit of U.S. Provisional Application No. 63/424,681 filed Nov. 11, 2022, hereby incorporated by reference herein in its entirety.

### BACKGROUND OF THE INVENTION

Phased array antennas can be a way to realize high antenna gains commonly associated with large reflector antennas but can be physically constrained to a relatively low profile surface. This allows the antenna to consume a much smaller volume of space compared to conventional reflector antennas. When the phased array incorporates active phase shifting (or time delay) controls distributed throughout the antenna, the beamsteering angle of the antenna can be controlled without physically slewing and pointing the antenna to the desired beam pointing direction. This has the benefit of no moving parts and a pointing speed consistent with electronic circuit reconfiguration times (on the order of microseconds to nanoseconds). Phased array antennas with electronic steering controls may commonly be referred to as Electronically Steered Antennas (“ESA”). There is a need for method and systems of controlling the ESA to lower the complexity involved with two-dimensional beamsteering (perhaps up/down and even left/right relative to the physical boresight of the antenna).

Conventional ESA's may incorporate a phase shifting device at each unit cell of the array. The array can be comprised of M by N unit cells that are uniformly distributed to fill out a two dimensional area. Since phase shifting technology generally incurs signal loss, the unit cells can commonly include an amplifier that is between the unit cell radiator and the phase shifter. In receive mode, this amplifier sets the system noise figure by amplifying the signal to a level that is much greater than the loss of the phase shifting device that is downstream. All unit cell received signals are combined to realize the signal reception of a relatively larger aperture (antenna) area. In transmit mode, the signal distributed to each unit cell passes through the phase shifter with some loss in amplitude; however, the amplifier gain may typically be set to ensure that full transmit power is achieved by each unit cell (UC) amplifier. Because of the unique unit cell controls necessary to steer the antenna beam in two dimensions, the overall system complexity is quite high, i.e., M*N unique device controls required. Conventional ESA's can provide exceptional performance but with considerable cost and thermal management challenges associated with state of the art integrated circuits.

There are a number of existing competing alternatives to ESA' s. These include the continuous transverse stub (“CTS”) antenna, metamaterial antennas having active controls, and even lens array antennas. The CTS antenna can reduce the number of phase shifters by including a mechanism. This can sacrifice speed, size, and reliability to yield a lower cost system. The actively controlled metamaterial antennas trade aperture losses and considerable high risk development cost to potentially achieve a lower recurring cost antenna. The lens array antenna (array of electronically “switched” lens apertures) trades lower aperture efficiency with grating lobes and higher volume to reduce cost. The lens array technology remains unproven to demonstrate a robust means of dealing with the grating lobe problem. All of these architectures have a place in practical, affordable antenna systems. Each approach trades off some level of performance attainable by ESA's in order to realize a lower cost architecture.

In order to electronically scan antennas, a relative phase could be controlled at or even near a half wavelength separation between the unit cell radiators (for wide scan systems). The benefits of ESA's can include low profile, beam agility, and even high aperture efficiency. An architecture introduced by Crane in U.S. Pat. No. 4,731,614, hereby incorporated by reference herein, may identify how the relative phase of a unit cell in a fully populated phased array can be controlled with only M+N phase shifters. This can result in a substantial reduction in ESA complexity by reducing the beamforming to simple subsystems residing at the row and columns of the ESA. At the time this was introduced, microwave and millimeter wave integrated circuit technology was not mature. There is a need for improved technologies not provided in past systems.

### SUMMARY OF THE INVENTION

The present application includes a variety of aspects, which may be selected in different combinations based upon the particular application or needs to be addressed. In various embodiments, the application may include phased array antenna systems and methods that can reduce system complexity perhaps to realize electronically steered antennas.

It is an object of the application to provide a multilayered phased array antenna system.

It is another object of the application to provide a multi-unit chip associated with multiple unit cells such as at least four unit cells, at least eight unit cells, at least sixteen unit cells, at least thirty two unit cells, and the like of an efficient phased array antenna system.

It is yet another object of the application to provide better cost of implementation perhaps through use of RFIC technology.

It is an object of the application to address heat dissipation perhaps through use of wafer level packaging and/or higher power efficiency RFIC processes not commonly applicable by conventional systems.

Naturally, further objects, goals and embodiments of the application are disclosed throughout other areas of the specification, claims, and drawings.

### BRIEF DESCRIPTION OF THE DRAWINGS

FIG. 1 shows a phased array antenna system having row-column phased array architecture in accordance with some embodiments.

FIG. 2 shows an example of a unit cell block diagram in accordance with some embodiments.

FIG. 3 shows an example of signals utilized in a power efficient phased array antenna system in accordance with some embodiments.

FIG. 4 shows an example of a unit cell with a transmit amplifier in accordance with some embodiments.

FIG. 5 shows an example of a unit cell with a receiver amplifier in accordance with some embodiments.

FIG. 6 shows an example of a unit cell with a frequency multiplier in accordance with some embodiments.

FIG. 7 provides details about an analog devices AD9361 RF transceiver in accordance with some embodiments.

FIG. 8 shows an example block diagram for a quad module to drive four adjacent unit cells in accordance with some embodiments.

FIG. 9 shows an example of a side view of a printed circuit board showing multiple layers in accordance with some embodiments.

FIG. 10 shows an example of a top view of a printed circuit board showing a row manifold network in accordance with some embodiments.

FIG. 11 shows an example of radiators on a printed circuit board in accordance with some embodiments.

FIG. 12 shows an example of a top view of printed circuit board with components installed in accordance with some embodiments.

FIG. 13 shows an example of a perspective view of printed circuit board with components installed in accordance with some embodiments.

FIG. 14 shows an example of a perspective view of printed circuit board with components installed in accordance with some embodiments.

### DETAILED DESCRIPTION OF THE INVENTIONS

It should be understood that embodiments include a variety of aspects, which may be combined in different ways. The following descriptions are provided to list elements and describe some of the embodiments of the application. These elements are listed with initial embodiments; however, it should be understood that they may be combined in any manner and in any number to create additional embodiments. The variously described examples and preferred embodiments should not be construed to limit the embodiments of the application to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

In the past, metamaterial antennas and continuous transverse stub (“CTS”) antennas have been used. Metamaterial antennas have a high control complexity, use liquid crystal control technology, and have 2D electronic steering. CTS antennas use 1D electronic steering and mechanical steering. Neither CTS nor metamaterial antennas have changed the way high gain, steered antennas are implemented. There is a need for low cost 2D steered antennas.

Embodiments of this application provide novel row-column phased array (“RCPA”) antenna architectures which may enable a lowest beamsteering complexity, with low front end losses, high front end RF power output, and even low noise figure. This architecture can enable row and column only beamsteering controls which may substantially reduce the control realization problem associated with conventional and metamaterial 2D electronically scanned arrays. The implementation may take advantage of all industry gains in radio-frequency integrated circuit (“RFIC”) technology and can use common printed circuit board manufacturing for system realization. Antenna architecture can be fabricated by any board shop and may not require specialized processes that seems to have been required for low loss metamaterial phased arrays.

Embodiments of the application may provide a power efficient phased array antenna system (1) comprising a multilayered (2) phased array antenna system; a plurality of antennas (3) arranged into an array of rows (4) and columns (5); a plurality of unit cell chips (6), each of the unit cell chips is associated with each of the antennas; a plurality of row network operators (8), each of which is associated with a row of the antennas; a plurality of column network operators (10), each of which is associated with a column of the antennas; wherein in a transmit (12) or a receive mode (13) each of the row network operators is configured to provide a row operator generated intermediate frequency signal (14) to one corresponding antenna (15) in a corresponding row of antennas; wherein in the transmit or the receive mode each of the column network operators is configured to provide a column operator generated local oscillator signal (17) to one corresponding antenna (18) in a corresponding column of the antennas; wherein in a receive mode, each of the row network operators (8) is configured to receive a converted intermediate frequency signal (20) from a corresponding antenna in a corresponding row of the antennas; wherein in the transmit mode, each of the unit cell chips are configured to combine (21) the row operator generated intermediate frequency signal (14) from the corresponding row network operator (8) and the column operator generated local oscillator signal (17) from the corresponding column network operator (10) to create a radio frequency signal (22) to be transmitted from the antenna; wherein in said receive mode, each of said unit cell chips are configured to utilize: a row operator delayed intermediate frequency signal (24) from one of the corresponding row network operators; the column operator generated local oscillator signal (17) from the corresponding column network operator; and a received radio frequency signal (25) received from the associated antenna to create a converted intermediate frequency signal (26).

As may be understood from FIG. 1, embodiments may rely on series feeding transmission line networks, a collection of horizontal row networks, and even a collection of vertical column networks. A plurality of antennas (3) may be arranged into an array of rows (4) and columns (5). A column manifold (51) may be located near a plurality of column network operators (10) and a row manifold (52) may be located near a plurality of row network operators (8). The array may be controlled by a controller (7) which may include a software defined radio digitizer (44), may switch the array between a transmit mode (12) and receive mode (13). A phase shifting device may be located at the input to each network perhaps to establish a one-dimensional phase gradient across an aperture. Row and column networks may intersect at each unit cell chip (6). Embodiments of the application may provide the inclusion of unit cell controls perhaps for transmit and receive operations and/or polarization control operations via a unit cell chip (6). Since these can be controlled by a global command, this can introduce little complexity to a system and can be compatible with GaAs or GaN among other integrated circuit processes.

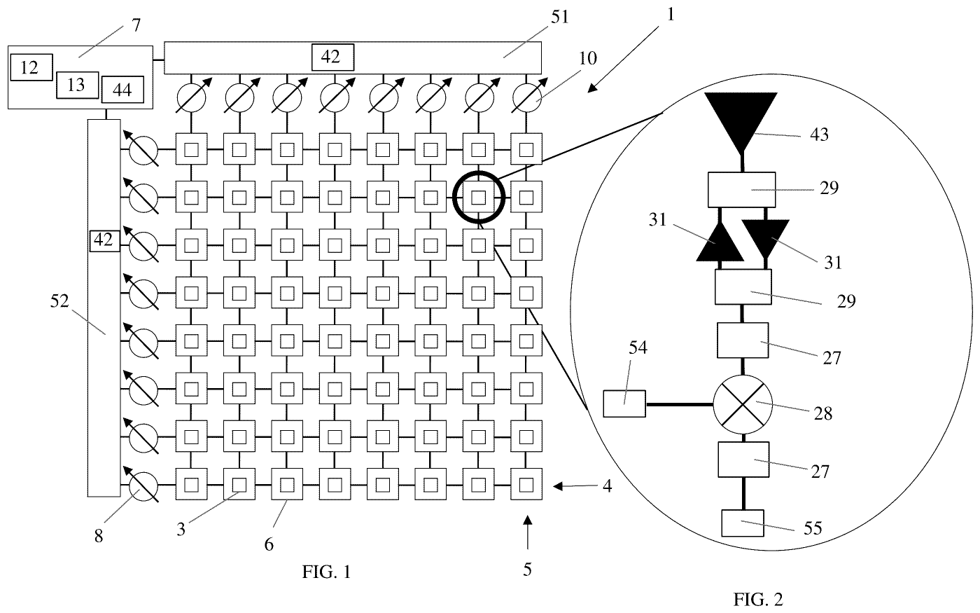

As shown in FIG. 2, a unit cell chip (6) may be connected to a column manifold (55) and a row manifold (54) and may include at least one bandpass filter (27) (which can be optional), a mixer (28), at least one transmit/receive switch (29) (which may be single switch), a local oscillator (30), an amplifier (31), a radiator (43), any combination or permutation thereof, or the like. A mixer (28) may multiply two phase terms together so that it may uniquely add the phases together based on the location in the array. Because the phase setting operation may be performed by the mixing of two signals, a bandpass filter (27) may follow to reject unwanted spurious signals. The signal can be amplified with an amplifier (31) prior to delivery into the radiator (43). In a receive mode, a received radio frequency signal (25) may be processed through a receiver amplifier (31), then a mixer (28), then a bandpass filter (27). Because all unit cells may require a common “transmit” or even “receive” command, the complexity may be reduced to a single high/low state for an entire phased array.

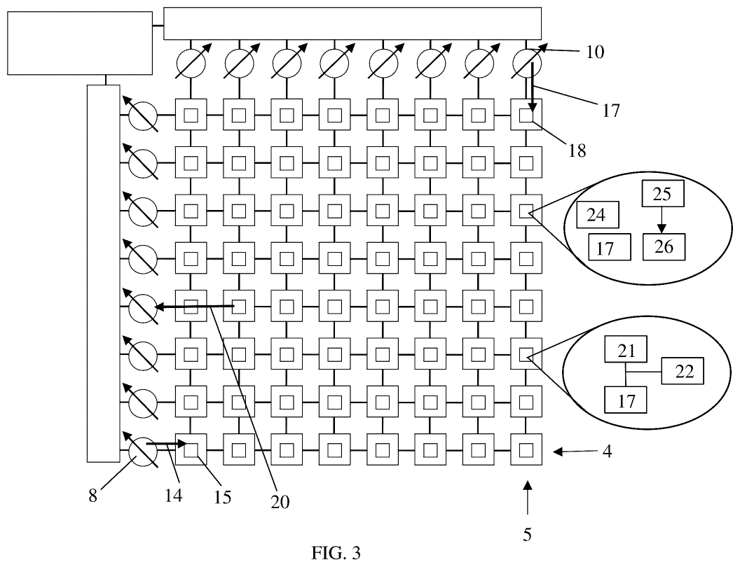

FIG. 3 shows a plurality of row network operators (8), each of which is associated with a row (4) of said antennas and a plurality of column network operators (10), each of which is associated with a column (5) of said antennas. In either a transmit (12) or a receive mode (13) each row network operators can provide a row operator generated intermediate frequency signal (14) to a corresponding antenna (15) in a corresponding row and each column network operators can provide a column operator generated local oscillator signal (17) to a corresponding antenna (18) in a corresponding column. When in a receive mode, each row network operators (8) may receive a converted intermediate frequency signal (20) from a corresponding antenna in a corresponding row. When in a transmit mode, each unit cell chip, or perhaps chip set, can combine the row operator generated intermediate frequency signal (14) and the column operator generated local oscillator signal (17) to create a radio frequency signal (22) to be transmitted from the antenna. When in a receive mode, each unit cell chip can utilize: a row operator delayed intermediate frequency signal (24) from one of the corresponding row network operators; a column operator generated local oscillator signal (17) from the corresponding column network operator; and perhaps even a received radio frequency signal (25) received from an associated antenna to create a converted intermediate frequency signal (26).

Row network operators and column network operators may have a plurality of ports which can transmit or even receive intermediate frequency signals and may include phase shifting capabilities perhaps with a phase shifter. Row and column phase shifters may be controlled and the overall number of controls can be M+N perhaps rather than M×N. The location of the shifters may be reduced to one vertical and even one horizontal edge of the array. It may be desirable in understanding the integration challenges posed by these new architectures by determining the best technology to integrate the RFIC required perhaps for high frequency operation. All technologies can be viable such as but not limited to gallium arsenide (“GaAs”), gallium nitride (“GaN”), silicon-germanium (“SiGe”), silicon-based processes, and the like.

As mentioned, a phased array system may include phase shifters, such as low frequency phase shifters and distributed up and/or down frequency conversion. Each phased array unit cell may include conventional transmit and receive amplifiers, transmit/receive (“T/R”) switches, antenna radiators, and the like. A mixer and even two bandpass filters (“BPF”) may be in a unit cell. Bandpass filters may reduce the amplitude of spurious harmonics, local oscillator frequency, radio frequency signal leakage, intermediate frequency leakage, and the like.

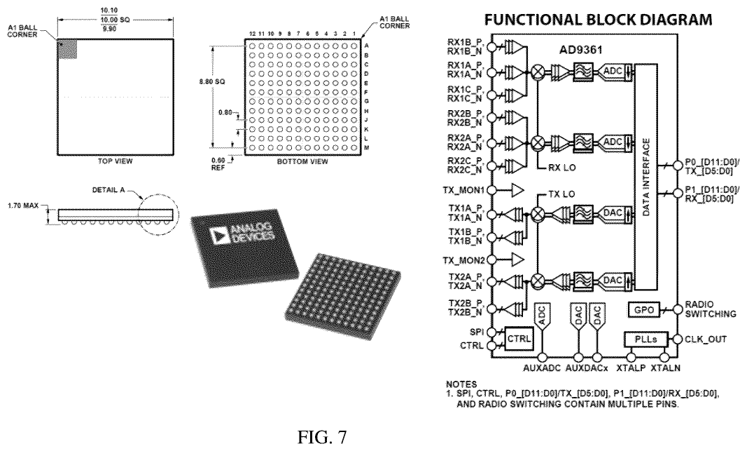

As a non-limiting example, if the RF frequency is 17 GHz, IFrow is 7.5 GHz, and IFcolumn is 9.5 GHz, then on transmit, the BPF on the RF port can prevent IFrow and IFcolumn leakage perhaps as well as eliminating m*IFrow+/−n*IFcolumn harmonics. On receive through the column manifolds, the column path BPF may filter out row manifold IF leakage, RF leakage, and even harmonics perhaps associated with m*IFrow+/−n*RF combinations. Distributed filters could be realized within the phased array series fed manifolds; however, it may be desirable to place the filters within a RFIC. Module level up/down frequency conversion may be practiced in the wireless industry using SiGe based common modules. The Analog Devices AD9361, as may be understood in FIG. 7, may provide an example of a baseband interface to the system signal processor and an intermediate IF to RF interface to radiators. FIG. 7 shows a non-limiting example of commercial parts incorporated multiple IF to RF conversion as perhaps becoming commonplace.

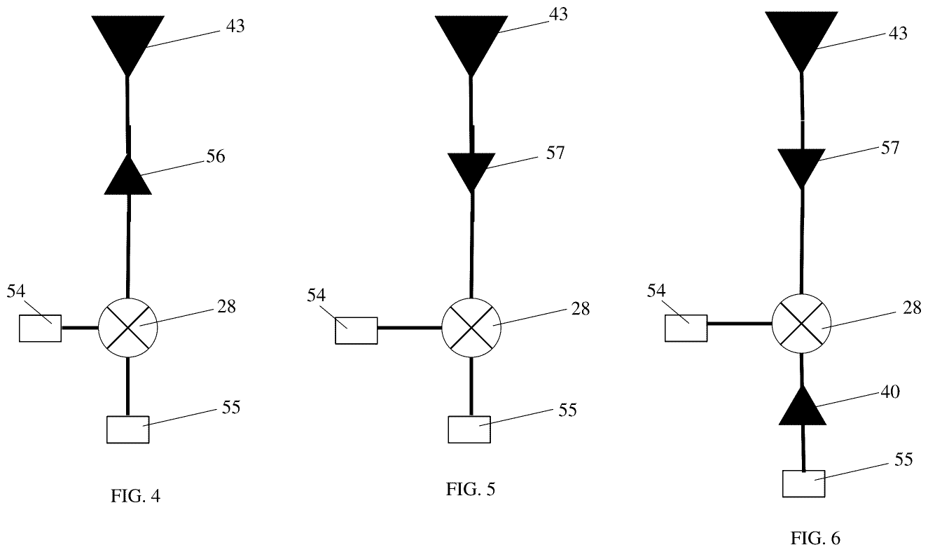

FIGS. 4-6 shows non-limiting examples of additional unit cell functional sets including: IFr row manifold, (54) IFc column manifold (55), a mixer (28), a TX amplifier (56), and a radiator (43) in FIG. 4; IFr row manifold, (54) IFc column manifold (55), a mixer (28), a RX amplifier (57), and a radiator (43) in FIG. 5; and IFr row manifold, (54) IFc column manifold (55), a frequency multiplier (40), a mixer (28), a RX amplifier (57), and a radiator (43) in FIG. 6. In some embodiments, unit cell chips may utilize radio-frequency integrated circuitry.

With the current state of the art integrated circuit technology, Electronically Steerable Antenna (“ESA”) core chips can provide phase, amplitude, transmit and receive switching, and even multi-channel combining perhaps all in a single chip that is sized to enable phased array operations at millimeter wavelengths. The millimeter wavelengths core chips can be implemented in silicon germanium (“SiGe”) processes that accommodate control and radio frequency circuitry within the same process. However, the SiGe implementation can sacrifice power efficiency often at about 10% or lower. Other processes such as gallium arsenide (“GaAs”) or even gallium nitride (“GaN”) could be considered but may not accommodate control aspects needed for attenuator and phase shifters adequately. Past architectures may be combined with unit cell amplification to achieve very high aperture efficiency and even high-power efficiency perhaps since there are no sophisticated phase shifters or attenuators at the unit cell required. Furthermore, by introduction of band limiting amplifiers and/or filtering within the unit cell integrated circuitry, harmonic frequency selection, and signal leakage through the mixer circuit can be managed for high performance applications. Any mixing circuit can require an adequate local oscillator drive level (signal strength) to perform properly. Introduction of a local oscillator drive amplifier may achieve optimal performance. Inclusion of a local oscillator frequency multiplier may provide optimal frequency planning and can enable a wide frequency range of operation by the array with minimal to no harmonic filtering required.

Embodiments may include bandwidth and multiple beam operations. By incorporating modern software defined radio (e.g., digital) interfaces to the rows and columns, wide instantaneous bandwidth operation can be enabled. This may also be realized using true time delay modules (42) which can be incorporated into row and column network operators. In order to support wideband beamsteering in ESA chips, perhaps where the beam does not steer with frequency but may rather be stationary, true time delay devices may be required which can be difficult to incorporate at the unit cell level. However, true time controls can be easily accommodated at the row and columns.

Multiple beam operation can be conceived by systems containing digital receivers at the element or subarray level. For this architecture, subarrays may consist of orthogonal sets of rows and columns that can intersect. By using digital transceivers, multiple beam operation can be realized on transmit or receive operations. In transmit mode, all signals passed through amplifiers may need to maintain linear operation to avoid performance degrading intermodulation products.

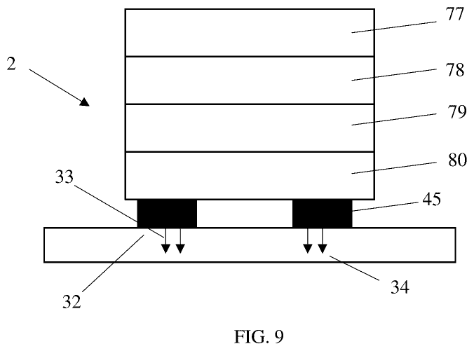

Embodiments of the application may provide the use of surface mounted couplers (45) or even divider components perhaps to reduce the size of the couplers (or even signal dividers) necessary to distribute the row and column signals perhaps through the network and even to minimize the number of printed circuit layers required to implement the system. Other embodiments may provide the use of wafer level packaging (“WLP”) of the integrated circuits perhaps for heat dissipation management which may be critical to achieving high reliability operation and long life. WLP may be a process where packaging components are attached to an integrated circuit before the wafer on which the integrated circuit is fabricated—may be diced. In WLP, the top and bottom layers of the packaging and the solder bumps can be attached to the integrated circuits while they are still in the wafer. This process differs from a conventional process, in which the wafer is sliced into individual circuits (dice) before the packaging components are attached. The WLP integrated circuits can enable heat generated within the components to be transferred through the top of the part. By incorporating a heat management system based on removal of heat through the top of the parts, tiled implementations of the row and column phased array may be feasible to achieve state of the art in low profile ESA solutions. In some embodiments, a heat dissipator (32) may be utilized and may transfer heat (33) from a multilayered phased array antenna system out of bottom layer (34) of a multilayered phased array antenna system as shown in FIG. 9.

Embodiments may provide an efficient phased array antenna system comprising: a multi-unit cell chip (60) associated with at least four antennas (3) of a phased array antenna system; two row network operators (8) associated with said at least four antennas; two column network operators (10) associated with said at least four antennas; wherein said row network operators are configured to provide row operator generated intermediate frequency signals (14) to said at least four antennas in a transmit or a receive mode; wherein said column network operators are configured to provide column operator generated local oscillator signals (17) to said at least four antennas in said transmit or said receive mode; wherein said row network operators are configured to receive a converted intermediate frequency signal (20) from said at least four antennas in said receive mode; wherein said multi-unit cell chip is configured to combine said row operator generated intermediate frequency signals and said column operator generated local oscillator signals to create a radio frequency signal (22) to be transmitted from said at least four antennas in said transmit mode; wherein said multi-unit cell chip is configured to utilize: row operator delayed intermediate frequency signals (24) from said row network operators; said column operator generated local oscillator signals from said column network operators; and perhaps even a received radio frequency signal (25) received from said at least four antennas to create a converted intermediate frequency signal (26).

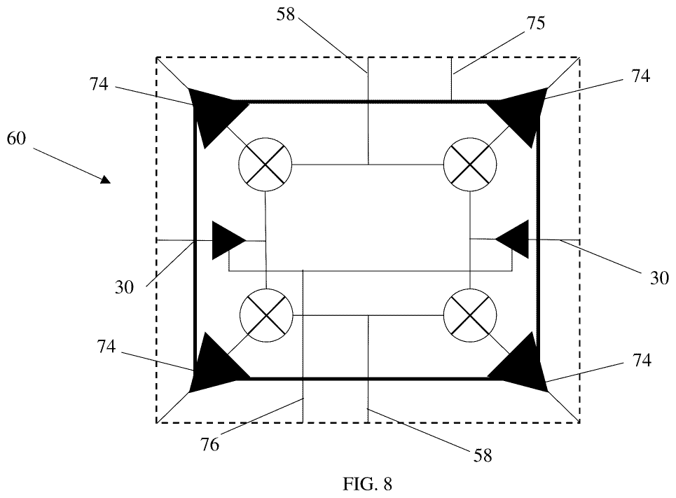

FIG. 8 illustrates a non-limiting example of integrated circuit block diagram containing four adjacent channel function sets in a quad-module. A quad module may drive four adjacent unit cells (74) in an electronically steered antenna. In transmit mode, IFrow and IFcolumn may be generated as intermediate frequency signals (58) and may have voltages (75) and (76). One can serve as the local oscillator (30) and may be unmodulated. The other may be a modulated signal perhaps using the radar (or communications) modulation of choice. On receive mode, the same strategy may apply where one of the IF signals may serve as an LO (as illustrated, in this example, IFrow is the LO). The incoming RF signal may be mixed down to IF perhaps with the use of the IFrow as the LO. The received signal may be provided to the column manifold in the form of IFcolumn. This reduction in control complexity at the unit cell can lead to a substantial reduction in chip size and interfaces required. It should be understood that the LO signal could alternatively be provided via the column and the received signal provided via the row. In embodiments, there may be two column operator generated local oscillator signals and two converted intermediate frequency signals. Some configurations may include four mixers and four amplifiers each associated with each of the four antennas. In addition, a multi-unit cell chip may have a two by two block circuitry.

A multi-unit cell chip (60) may be associated with a number of antennas such as at least eight antennas, at least sixteen antennas, at least thirty two antennas, or the like.

By realizing unique unit cell level phase controls through a much smaller number of row and column phase controls, the control problem complexity can be substantially reduced. First, a unique phase shifter setting may no longer be required for distribution at the unit cell level. This can remove control components and even manifolding from the phased array architecture. Second, the required amount of bits of control may be substantially reduced perhaps since far fewer phase shifters may be populated in the array. This can result in a reduced speed control system (or even a reduced latency in control delivery). These simplifications to the phased array architecture may manifest in simpler PCB layouts and even RFIC components. A reduction in physical and even electrical complexity can provide a cost reduction. As a non-limiting example, a conventional phased array consisting of 33×33 unit cells may require 999 modules that can each require a unique control message to point. In embodiments of the present application, a RCPA system may require about 66 uniquely controlled phase shifters. This may provide greater than an order of magnitude reduction in system complexity.

Phased array theory is represented by the following mathematical expression:

$$AF ( θ , ∅ ) = {\sum }_{m = 1}^{M} {\sum }_{n = 1}^{N} {a}_{mn} {e}^{jk ( {x}_{mn} ( sin ( θ ) cos ( ∅ ) - sin ( {θ}_{o} ) sin ( {∅}_{o} ) ) + {y}_{mn} ( sin ( θ ) cos ( ∅ ) - sin ( {θ}_{o} ) sin ( {∅}_{o} ) ) )} \qquad ( 1 )$$

Expression 1 is well known and demonstrates the unique phase offset required is the combination of a row (x) and column (y) term associated with the rows and columns of a two-dimensional phased array antenna. These terms are separable and are the result of complex multiplication. Expression 2 shows the same formula with the terms rearranged

$$AF ( θ , ∅ ) = {\sum }_{m = 1}^{M} {\sum }_{n = 1}^{N} {a}_{mn} {e}^{jk ( {x}_{mn} sin ( θ ) cos ( ∅ ) + {y}_{mn} sin ( θ ) sin ( ∅ ) )} {e}^{- jk ( {x}_{mn} ( sin ( {θ}_{o} ) cos ( {∅}_{o} ) + {y}_{mn} sin ( {θ}_{o} ) sin ( {∅}_{o} )} \qquad ( 2 )$$

Expression 2 separates the phased array control term which sets all the radiating element signals for maximum combining at angle (□o, □o) as a separate exponential term. The phase control term can be further simplified as

e^{-jk(x}^{ₘₙ} ^{sin(θ}^{ₒ}^{)cos(ø}^{ₒ}^{)+y}^{ₘₙ} ^{sin(θ}^{ₒ}^{)sin(ø}^{ₒ}⁾⁾=e^{-jk(x}^{ₘₙ} ^{sin(θ}^{ₒ}^{)cos(ø}^{ₒ}⁾⁾e^{-jk(y}^{ₘₙ} ^{sin(θ}^{ₒ}^{)sin(ø}^{ₒ}⁾⁾ (3)

e^{-jk(x}^{ₘₙ} ^{sin(θ}^{ₒ}^{)cos(ø}^{ₒ}⁾⁾e^{-jk(y}^{ₘₙ} ^{sin(θ}^{ₒ}^{)sin(ø}^{ₒ}⁾⁾=e^{jφr}ejφc (4)

The phase control term has been simplified to the complex multiplication of a row and a column term. The mixer in the RCPA architecture provides the means to realize the complex multiplication of the row and the column phase terms.

An additional consideration may include beam squint versus frequency. A common method of beamsteering may be to sweep over a relatively broad frequency range perhaps using a fixed delay network across the radiators. Embodiments of a RCPA system may provide beam squint over wide frequency excursions from the nominal beamsteered location. The instantaneous bandwidth for a given beam state can be sufficiently broad to support a variety of waveform bandwidths. However, to support much wider bandwidths, true time delay controls can be applied that can counter the fixed delay network between radiators. The column level true time controls can compensate for the row level delays and the row level true time controls can compensate for the column level network delays across frequency. By using coupling networks hanging off of the series fed lines, much wider bandwidth operations can be supported and may not rely on resonant spacing designs to provide wideband matching of the network. Embodiments may include a planned frequency range such as but not limited to: C bands, X bands, Ku bands, Ka bands, V bands, W bands, between about 4 GHz to about 100 GHz, any combination or permutation thereof, or the like.

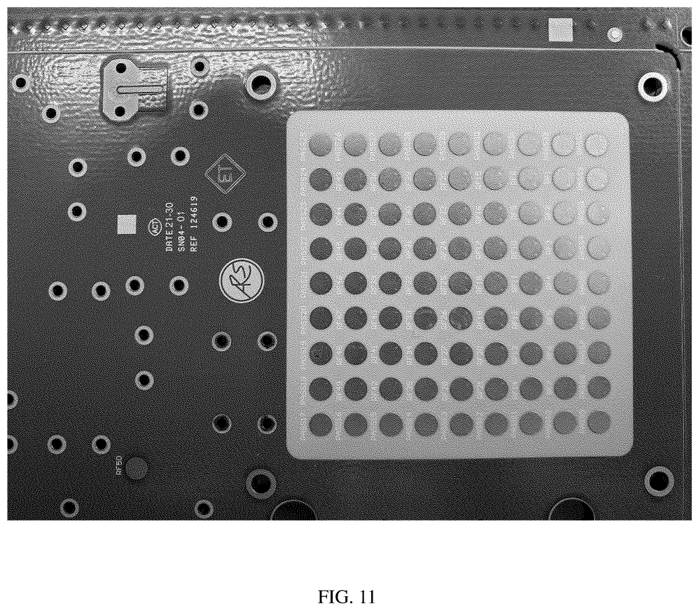

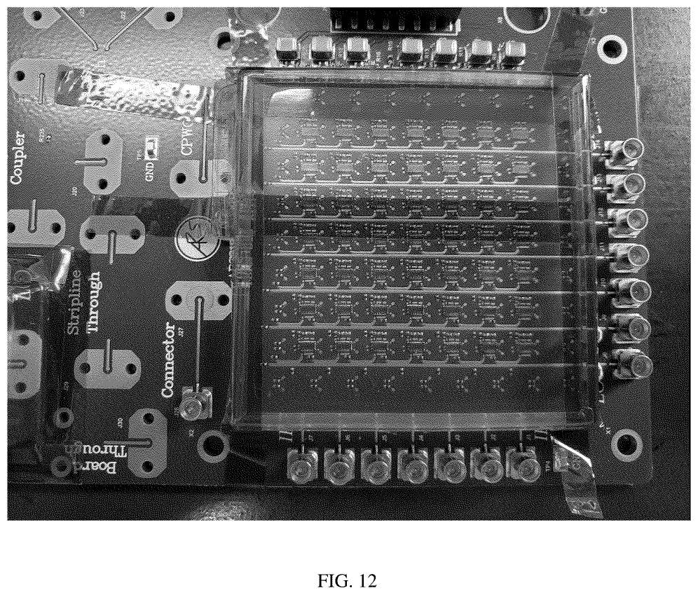

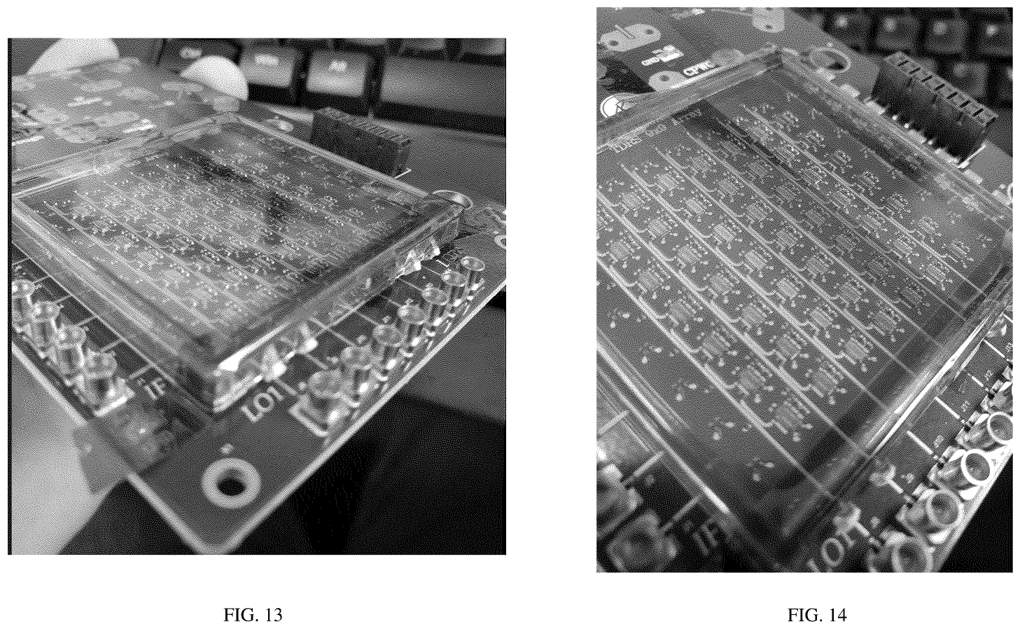

Embodiments of the application may provide an RCPA integration concept which utilize printed circuit board fabrication and assembly processes. Because each unit cell may have signal amplification, the distribution losses may not appreciably impact the array performance. However, the amplitude distribution can be affected by line loss. Also, since the distribution may be at IF, the loss per inch can be significantly lower than at RF. Nevertheless, the loss across the network may need to be understood perhaps to ensure that the desired amplitude distribution can be achieved. FIGS. 9-14 shows a non-limiting example of a notional RCPA implementation concept using PCB's such as using a standard PCB fabrication and assembly which may be capable of producing a RCPA antenna. As shown, the top layer may be dedicated to realizing the radiating surface (e.g., microstrip patches or the like). Microstrip patches can achieve about 20% bandwidths perhaps using tall substrate heights and/or incorporation of a stacked patch architecture. Subsequent layers can provide physical separation of the two distribution networks for row and even column controls. A backside surface may provide ample room for surface mount integration of the necessary RFIC's.

As shown in FIG. 9, a multilayered phased array system (2) may have at least two layers, at least three layers, and at least four layers, or the like. Layers may include a radiator layer (77), a power and control layer (78), a row manifold layer (79), perhaps even a column manifold layer (80), or the like. However, antennas, unit cell chips, row network operators, column network operators may be located on the same or different layers of a multilayered phased array antenna system. A DC power supply connected to said multilayered phased array antenna system is generally required.

A multilayered phased array system (2) may have at least one buried layer such as a buried strip line networks which can be used to realize at least one of the manifolds. Microstrip lines on the back side surface can be used to realize the other manifold. Transitions (e.g., plated through hole vias) between layers can be a challenge to implement but may be feasible at millimeter wave frequencies. RFIC' s implemented in SiGe and even GaAs may be proven where all thermal dissipation has been dissipated through the top of the package. This can be a simple strategy for antenna integration to the platform perhaps while providing a natural (backside) thermal interface.

The following are some of the advantages of the techniques discussed and disclosed herein in accordance with various embodiments: a phased array architecture that can reduce two-dimensional beamsteering controls to a row plus a column set of signal phase or delay controls; phased array architecture that can utilize distributed mixing signal products to realize row and column control combining; a phased array architecture that can be realized using conventional and novel manufacturing methods; a phased array architecture that can utilize conventional and state-of-the-art RF integrated circuits for transmit and receive signal amplification; a phased array architecture that can support any radiating element intended to support phased array operation; phased array architecture that may be capable of supporting sensing and communication applications; a phased array architecture that may be capable of supporting low profile or conformal implementations; inclusion of amplifiers at each unit cell; frequency multiplier perhaps to improve frequency planning; implementing in GaAs, GaN or SiGe with WLP perhaps to transfer heat out top of IC which may be important for tile implementations; inclusion of globally controlled TR switch and/or Polarization controls; implementation as a quad or even double unit cell IC perhaps to minimize the inputs and outputs; series and/or corporate distribution networks for IF (row) and LO (column); use of surface mount couplers or even divider components perhaps to reduce layout complexity; time delay controls perhaps in lieu of phase shifters at the row and column level; software defined radio (digitizer) perhaps in lieu of Receiver/Xmtr or LO distribution networks; enable multi-beam operations, true time delay, signal filtering, or the like; intermediate frequency up or down conversion perhaps between the SDR and the antenna; any combination or permutation thereof.

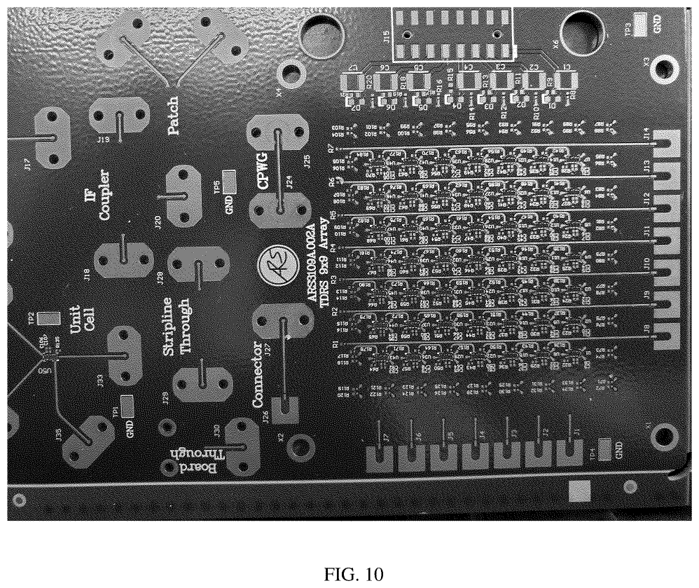

FIGS. 10-14 provide non-limiting examples of printed circuit boards showing a row manifold network, radiators on a printed circuit board, and a printed circuit board with components installed.

As can be easily understood from the foregoing, the basic concepts of the various embodiments of the present invention(s) may be embodied in a variety of ways. It involves both phased array antenna techniques as well as devices to accomplish the appropriate phased array antenna. In this application, the phased array antenna techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the various embodiments of the invention(s) and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified). In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the application is described in device-oriented terminology, each element of the device implicitly performs a function. Apparatus claims may not only be included for the device described, but also method or process claims may be included to address the functions of the embodiments and that each element performs. Neither the description nor the terminology is intended to limit the scope of the claims that will be included in any subsequent patent application.

It should also be understood that a variety of changes may be made without departing from the essence of the various embodiments of the invention(s). Such changes are also implicitly included in the description. They still fall within the scope of the various embodiments of the invention(s). A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of embodiments of the invention(s) both independently and as an overall system.

Further, each of the various elements of the embodiments of the invention(s) and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the invention(s), the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the invention(s) is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “transmitter” should be understood to encompass disclosure of the act of “transmitting”—whether explicitly discussed or not—and, conversely, were there effectively disclosure of the act of “transmitting”, such a disclosure should be understood to encompass disclosure of a “transmitter” and even a “means for transmitting.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function. As other non-limiting examples, it should be understood that claim elements can also be expressed as any of: components, programming, subroutines, logic, or elements that are configured to, or configured and arranged to, provide or even achieve a particular result, use, purpose, situation, function, or operation, or as components that are capable of achieving a particular activity, result, use, purpose, situation, function, or operation. All should be understood as within the scope of this disclosure and written description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in any information statement filed with the application are hereby appended and hereby incorporated by reference, however, as to each of the above, to the extent that such information or statements incorporated by reference might be considered inconsistent with the patenting of the various embodiments of invention(s) such statements are expressly not to be considered as made by the applicant(s).

Thus, the applicant(s) should be understood to have support to claim and make claims to embodiments including at least: i) each of the phase array antenna devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, it should be understood that in characterizing these and all other aspects of the various embodiments of the invention(s)—whether characterized as a device, a capability, an element, or otherwise, because all of these can be implemented via software, hardware, or even firmware structures as set up for a general purpose computer, a programmed chip or chipset, an ASIC, application specific controller, subroutine, logic, or other known programmable or circuit specific structure—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines, processor logic, and/or programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrases “comprising”, “including”, “containing”, “characterized by” and “having” are used to maintain the “open-end” claims herein, according to traditional claim interpretation including that discussed in MPEP § 2111.03. Thus, unless the context requires otherwise, it should be understood that the terms “comprise” or variations such as “comprises” or “comprising”, “include” or variations such as “includes” or “including”, “contain” or variations such as “contains” and “containing”, “characterized by” or variations such as “characterizing by”, “have” or variations such as “has” or “having”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 9 or any other claim” or the like, it could be re-drafted as dependent on claim 1, claim 8, or even claim 11 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the various embodiments of the application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A power efficient phased array antenna system comprising:
a multilayered phased array antenna system;
a plurality of antennas arranged into an array of rows and columns;
a plurality of unit cell chips, each of said unit cell chips is associated with each of said antennas;
a plurality of row network operators, each of which is associated with a row of said antennas;
a plurality of column network operators, each of which is associated with a column of said antennas;
wherein in a transmit or a receive mode each of said row network operators is configured to provide a row operator generated intermediate frequency signal to one corresponding antenna in a corresponding row of said antennas;
wherein in said transmit or said receive mode each of said column network operators is configured to provide a column operator generated local oscillator signal to one corresponding antenna in a corresponding column of said antennas;
wherein in a receive mode, each of said row network operators is configured to receive a converted intermediate frequency signal from a corresponding antenna in a corresponding row of said antennas;
wherein in said transmit mode, each of said unit cell chips are configured to combine said row operator generated intermediate frequency signal from said corresponding row network operator and said column operator generated local oscillator signal from said corresponding column network operator to create a radio frequency signal to be transmitted from said antenna;
wherein in said receive mode, each of said unit cell chips are configured to utilize:
a row operator delayed intermediate frequency signal from one of said corresponding row network operators;
said column operator generated local oscillator signal from said corresponding column network operator; and
a received radio frequency signal received from said associated antenna to create a converted intermediate frequency signal.

2. The phased array antenna as described in claim 1 wherein each of said plurality of unit cell chips comprises at least one bandpass filter, a mixer, at least one transmit/receive switch, a local oscillator, an amplifier, and any combination or permutation thereof.

3. The phased array antenna as described in claim 1 wherein in said receive mode, said received radio frequency signal is processed through a receiver amplifier, then a mixer, then a bandpass filter.

4. The phased array antenna as described in claim 1 and further comprising a heat dissipator.

5. The phased array antenna as described in claim 4 wherein said heat dissipator is configured to transfer heat created in said multilayered phased array antenna system out of said bottom layer of said multilayered phased array antenna system.

6. The phased array antenna as described in claim 1 wherein said plurality of unit cell chips each comprise a mixer.

7. The phased array antenna as described in claim 1 wherein said row network operators and said column network operators comprise a plurality of ports configured to transmit or receive intermediate frequency signals.

8. The phased array antenna as described in claim 1 wherein said row network operators and said column network operators comprise phase shifting capabilities.

9. The phased array antenna as described in claim 1 and further comprising a plurality of bandpass filters, each of which is associated with each of said antennas.

10. The phased array antenna as described in claim 9 wherein said bandpass filters are configured to reduce an amplitude of a component chosen from: intermediate frequency leakage, radio frequency signal leakage, spurious harmonics, and local oscillator frequency.

11. The phased array antenna as described in claim 1 and further comprising a plurality of amplifiers, each of which is associated with each of said antennas.

12. The phased array antenna as described in claim 1 and further comprising a single switch configured to switch said array of said antennas between said transmit mode and said receive mode.

13. The phased array antenna as described in claim 1 wherein said plurality of unit cell chips comprises radio-frequency integrated circuitry.

14. The phased array antenna as described in claim 13 wherein said radio-frequency integrated circuitry is chosen from gallium arsenide, gallium nitride, silicon-germanium processes and silicon-based processes.

15-26. (canceled)

27. An efficient phased array antenna system comprising:
a multi-unit cell chip associated with at least four antennas of a phased array antenna system;
two row network operators associated with said at least four antennas;
two column network operators associated with said at least four antennas;
wherein said row network operators are configured to provide row operator generated intermediate frequency signals to said at least two antennas in a transmit or a receive mode;
wherein said column network operators are configured to provide column operator generated local oscillator signals to said at least two antennas in said transmit or said receive mode;
wherein said row network operators are configured to receive a converted intermediate frequency signal from said at least two antennas in said receive mode;
wherein said multi-unit cell chip is configured to combine said row operator generated intermediate frequency signals and said column operator generated local oscillator signals to create a radio frequency signal to be transmitted from said at least two antennas in said transmit mode;
wherein said multi-unit cell chip is configured to utilize:
row operator delayed intermediate frequency signals from said row network operators;
said column operator generated local oscillator signals from said column network operators; and
a received radio frequency signal received from said at least four antennas to create a converted intermediate frequency signal.

28. The efficient phased array antenna system as described in claim 27 wherein said multi-unit cell chip is associated with a number of antennas chosen from at least eight antennas, at least sixteen antennas, and at least thirty two antennas.

29. The efficient phased array antenna system as described in claim 27 and further comprising two column operator generated local oscillator signals and two converted intermediate frequency signals.

30. The efficient phased array antenna system as described in claim 29 and further comprising four mixers and four amplifiers each of said mixer and amplifier associated with each of said four antennas.

31. The efficient phased array antenna system as described in claim 29 and further comprising a two by two block circuitry in said multi-unit cell chip.

32. The efficient phased array antenna system as described in claim 29 and further comprising a frequency multiplier in said multi-unit cell chip.
